(19) United States
(12) Patent Application Publication
(10) Pub. No.: US 2011/0278962 A1
(43) Pub. Date: Nov. 17, 2011

(54) LINEAR VIBRATOR

(75) Inventor: Jung Taek HONG, Suwon (KR)

(73) Assignee: SAMSUNG ELECTRO-MECHANICS CO., LTD.

(21) Appl. No.: 13/104,536

(22) Filed: May 10, 2011

(30) Foreign Application Priority Data
May 14, 2010 (KR) 10-2010-0045654

(51) Int. Cl. H02K 33/00

(52) U.S. Cl. 310/25

(57) ABSTRACT

There is provided a linear vibrator including: a housing having an internal space formed therein; a magnetic field unit including a yoke disposed in the internal space and a magnet mounted on one surface of the yoke, and interacting with a coil to which power is applied to thereby generate vibrations in the internal space; an elastic member configured of a housing fixing part fixed to an inner surface of the housing, a yoke fixing part surface-contacting the other surface of the yoke, and a plurality of connecting strip parts disposed such that an elastic space is formed between the housing fixing part and the yoke fixing part; and a clearance part formed between the yoke and the yoke fixing part, and preventing the connecting strip parts from contacting the yoke during the vibrations of the magnetic field unit.

### CROSS-REFERENCE TO RELATED APPLICATIONS

This application claims the priority of Korean Patent Application No. 10-2010-0045654 filed on May 14, 2010, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator capable of preventing an internal impact sound.

2. Description of the Related Art

A linear vibrator, which is a component converting electrical energy into mechanical vibrations using the principle of generating electromagnetic force, is mounted in an electronic apparatus such as a mobile communications terminal, a portable game machine, or the like, to be used to silently notify a user of call reception by transferring vibrations thereto.

In accordance with the recent trend for compactness and slimness in mobile communications terminals, a compact, multi-functional linear vibrator has also been mounted therein.

A stator and a vibrator, vibrated due to electromagnetic interaction therebetween, are disposed within an internal space of the linear vibrator, according to the related art.

Since internal components forming the vibrator and the stator are disposed in the internal space at a high level of density, interference is caused between the internal components due to the vibrations of the vibrator.

Interference between internal components may cause problems such as the generation of noise, damage, or the like.

Accordingly, there is a demand for research into a linear vibrator capable of reducing noise or improving the life span of internal components thereof by removing interference between the internal components, in spite of the internal components thereof being disposed at a high level of density.

### SUMMARY OF THE INVENTION

An aspect of the present invention provides a linear vibrator capable of reducing noise and extending the life span of the linear vibrator by including a yoke vibrated while being supported by an elastic member and having a magnet mounted thereon and including a clearance part between the elastic member and the yoke to thereby prevent the elastic member from contacting the yoke during vibrations.

According to an aspect of the present invention, there is provided a linear vibrator including: a housing having an internal space formed therein; a magnetic field unit including a yoke disposed in the internal space and a magnet mounted on one surface of the yoke, and interacting with a coil to which power is applied to thereby generate vibrations in the internal space; an elastic member configured of a housing fixing part fixed to an inner surface of the housing, a yoke fixing part surface-contacting the other surface of the yoke, and a plurality of connecting strip parts disposed such that an elastic space is formed between the housing fixing part and the yoke fixing part; and a clearance part formed between the yoke and the yoke fixing part, and preventing the connecting strip parts from contacting the yoke during the vibrations of the magnetic field unit.

The yoke may include a magnet fixing part having the magnet fixed thereto, a mass body fixing part being bent from the magnet fixing part in a mounting direction of the magnet to fix a mass body, and a claw part being bent from the mass body fixing part to support a bottom of the mass body.

The clearance part may be a groove formed in at least one of the magnet fixing part and the elastic member.

The housing may include a cylindrical upper case of which a lower portion is open and a bracket closing the lower portion of the upper case and having the coil mounted thereon.

A yoke plate may be provided on a surface opposite to a contact surface between the magnet and the yoke.

The coil may have a cylindrical shape such that a space in which the magnetic field unit moves is formed, and magnetic fluid preventing contact between the magnetic field unit and the coil may be provided in a clearance therebetween.

The clearance part may be formed within the yoke fixing part in a direction toward at least one of the connecting strip parts.

The clearance part may be formed in a connecting point between the yoke fixing part and at least one of the connecting strip parts in a direction from the connecting strip part toward the housing fixing part.

The elastic member may include a spring member, the yoke fixing part may have a flat plate shape, the housing fixing part may have an annular rim shape in which a center is open, and the connecting strip parts may have a spiral shape connecting the yoke fixing part and the housing fixing part.

The housing may include a damper formed on a surface thereof, the damper preventing the magnetic field unit from contacting the housing due to vibrations.

The yoke may include a magnet fixing part having one surface bonded to the yoke fixing part and the other surface fixed to the magnet, and an area of a bonding surface between the magnet fixing part and the yoke fixing part may be smaller than that of the yoke fixing part.

According to another aspect of the present invention, there is provided a linear vibrator including: a cylindrical upper case of which a lower portion is open; a bracket fixed to the open lower portion of the upper case to thereby form an internal space and having a coil fixed thereto, the coil having external power applied thereto; a magnetic field unit including a yoke disposed in the internal space and a magnet mounted on one surface of the yoke, and interacting with the coil to which power is applied to thereby generate vibrations in the internal space; an elastic member configured of a ring-shaped housing fixing part fixed to the upper case, a flat plate-shaped yoke fixing part fixed to the other surface of the yoke, and a plurality of spiral connecting strip parts disposed such that an elastic space is formed between the housing fixing part and the yoke fixing part; and a clearance part formed between the yoke and the yoke fixing part, and preventing the connecting strip parts from contacting the yoke during the vibrations of the magnetic field unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view schematically showing a linear vibrator according to an exemplary embodiment of the present invention;

FIG. 2 is a cross-sectional view schematically showing the linear vibrator of FIG. 1;

FIG. 3 is a perspective view schematically showing an elastic member according to an exemplary embodiment of the present invention;

FIGS. 4A and 4B are, respectively, a perspective view and a cross-sectional view of a yoke according to an exemplary embodiment of the present invention;

FIG. 5 is an enlarged cross-sectional view of part A of FIG. 2;

FIG. 6 is an enlarged cross-sectional view showing a first modified example of part A of FIG. 2; and

FIG. 7 is an enlarged cross-sectional view showing a second modified example of part A of FIG. 2.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, throughout the drawings, the same or like reference numerals will be used to designate the same or like components having the same functions within the scope of the similar idea.

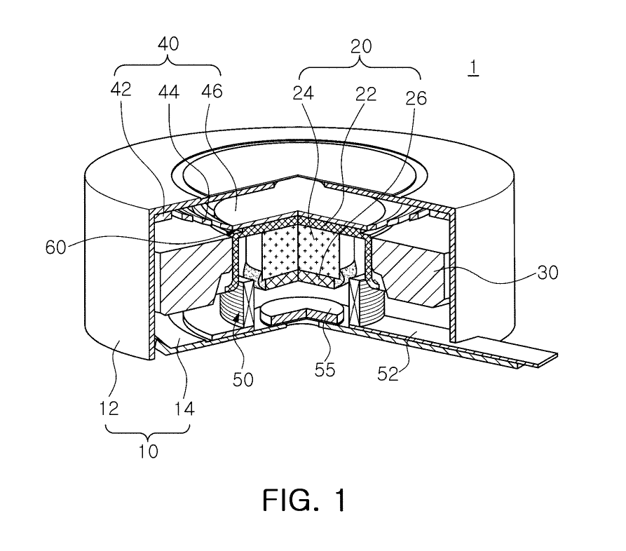

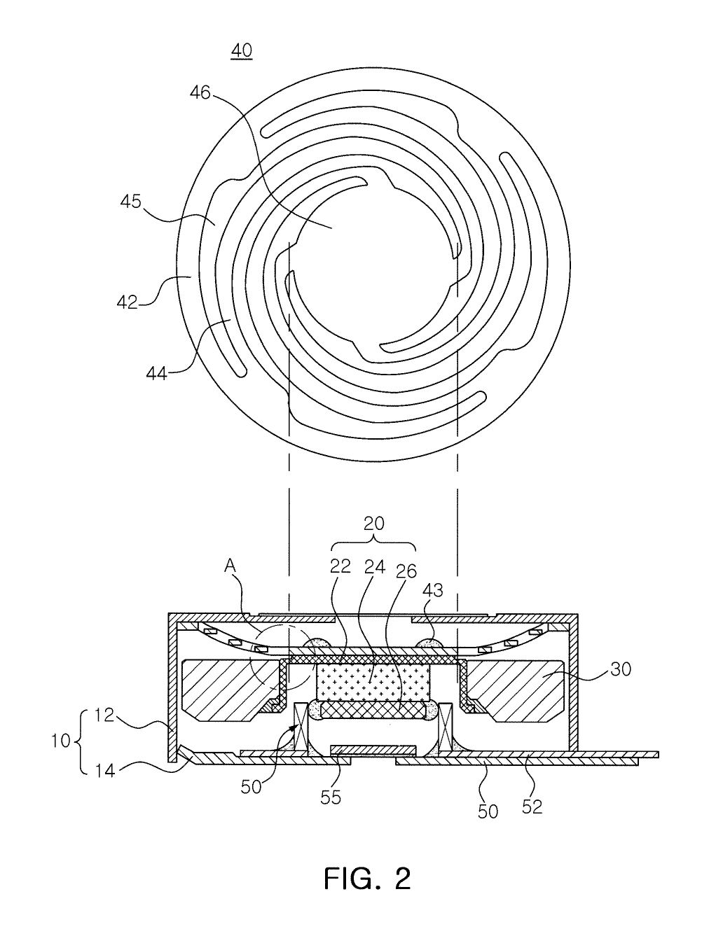

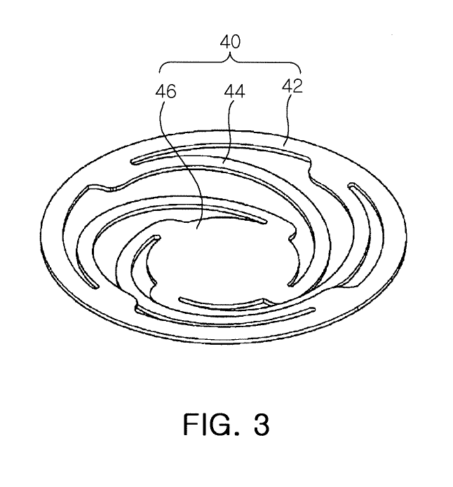

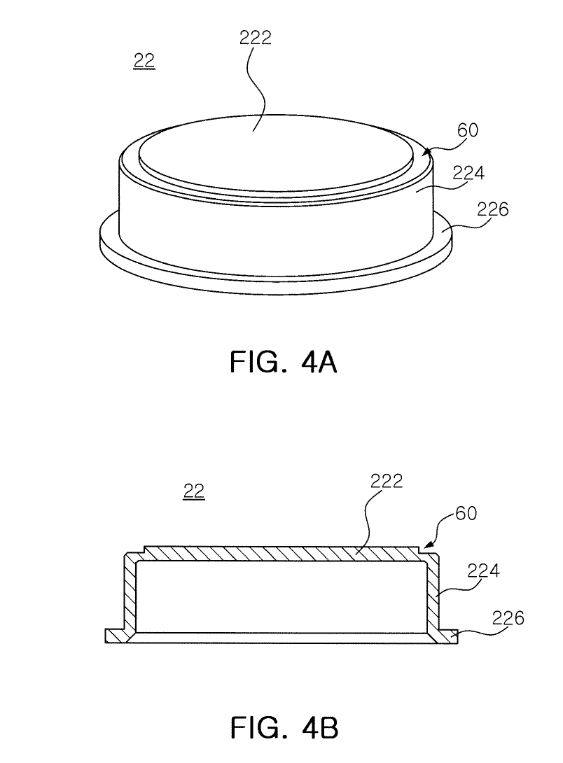

FIG. 1 is a partially cut-away perspective view schematically showing a linear vibrator according to an exemplary embodiment of the present invention; FIG. 2 is a cross-sectional view schematically showing the linear vibrator of FIG. 1; FIG. 3 is a perspective view schematically showing an elastic member according to an exemplary embodiment of the present invention; and FIGS. 4A and 4B are, respectively, a perspective view and a cross-sectional view of a yoke according to an exemplary embodiment of the present invention.

Referring to FIGS. 1 through 4, a linear vibrator 1 according to an exemplary embodiment of the present invention may include a housing 10, a magnetic field unit 20, an elastic member 40, and a clearance part 60.

The housing 10 may have an internal space formed therein, wherein the internal space has internal components forming a vibrator disposed therein. The housing 10 may be implemented by various methods, and particularly, should be provided such that the internal components may be easily disposed therein.

The housing 10 according to an exemplary embodiment of the present invention may include a cylindrical upper case 12 of which a lower portion is open and a bracket 14 closing the lower portion of the upper case 12 and having a coil mounted thereon.

The magnetic field unit 20 may generate a magnetic field having a predetermined strength, and may include a yoke 22 and a magnet 24 that are disposed in the internal space of the housing 10. In addition, the magnet 24 may include a yoke plate 26 formed on a surface opposite to a contact surface between the magnet 24 and the yoke 22.

The yoke 22 has a cylindrical shape in which an upper portion thereof is closed and a lower portion thereof is opened, and more specifically, may include a magnet fixing part 222 having the magnet 24 fixed thereto, a mass body fixing part 224 being bent from the magnet fixing part 222 in a mounting direction of the magnet 24 to fix a mass body 30, and a claw part 226 being bent from the mass body fixing part 224 to support a bottom of the mass body 30.

The magnet 24 may be fixedly bonded to one surface of the yoke 22 using an adhesive.

A diameter of an inner circumferential surface of the yoke 22 is larger than that of an outer circumferential surface of the magnet 24, such that an air gap (AG) having a predetermined size may be formed between the inner circumferential surface of the yoke 22 and the outer circumferential surface of the magnet 24.

The coil 50, allowing current to flow in a magnetic field formed by the magnetic field unit 20 and vibrate the magnetic field unit 20 may be disposed within the air gap (AG).

The coil 50 may have a cylindrical shape so that a space in which the magnetic field unit 20 can move is formed, and the magnetic fluid 54 preventing the contact between the magnetic field unit 20 and the coil 50 may be provided in a clearance therebetween.

A damper 55 may be formed in an upper surface of the bracket 14 and prevent the magnetic field unit 20 from contacting the housing 10 due to vibrations. The damper 55 may be made of a rubber material; however, a material of the damper 55 may be variously changed.

The elastic member 40 may include a housing fixing part 42 fixed to any portion of the upper case 12, a yoke fixing part 46 surface-contacting a surface opposite to the contact surface between the magnet 24 and the yoke 22, and a plurality of connecting strip parts 44 disposed such that an elastic space 45 is formed between the housing fixing part 42 and the yoke fixing part 46.

The housing fixing part 42 is a fixed end of the elastic member 40 fixed to the housing 10 that is not vibrated, and the yoke fixing part 46 is a free end of the elastic member 40 vibrated due to the vibration of the magnetic field unit 20.

The elastic member 40 may be a spring member, the yoke fixing part 46 may have a flat plate shape, the housing fixing part 42 may have an annular rim shape in which the center is open, and the connecting strip parts 44 may have a spiral shape connecting the yoke fixing part 46 and the housing fixing part 42.

Herein, the yoke 22 may include the magnet fixing part 222 having one surface bonded to the yoke fixing part 46 and the other surface fixed to the magnet 24, and an area of a bonding surface formed by bonding between the magnet fixing part 222 and the yoke fixing part 46 may be smaller than that of the yoke fixing part 46.

When the area the yoke fixing part 46 is larger than that of the bonding surface, assembly tolerance for the bonding may be secured to improve assembling efficiency.

The clearance part 60 may be formed between the yoke 22 and the yoke fixing part 46 of the elastic member 40 to prevent the connecting strip parts 44 of the elastic member 40 from contacting the yoke 22 during the vibrations of the magnetic field unit 20.

The clearance part 60 may be formed within the yoke fixing part 46 in a direction toward at least one of the connecting strip parts 44. That is, the clearance part 60 may be formed within a connecting point 41 between the yoke fixing part 46 and the connecting strip parts 44 in a direction from the connecting strip part 44 toward the housing fixing part 42.

In addition, the clearance part 60 may be formed in a connecting point 41 between the yoke fixing part 46 and at least one of the connecting strip parts 44 in a direction from the connecting strip part 44 toward the housing fixing part 42.

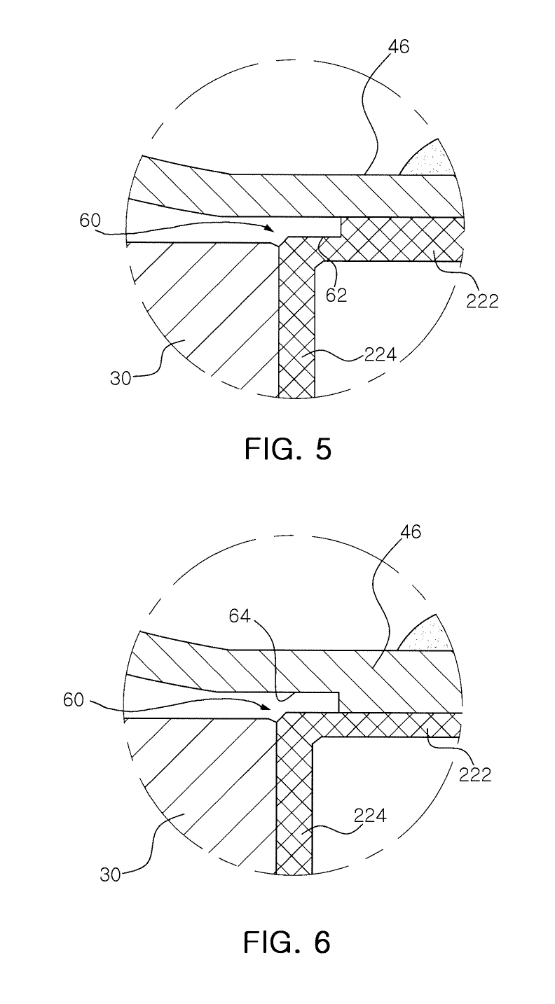

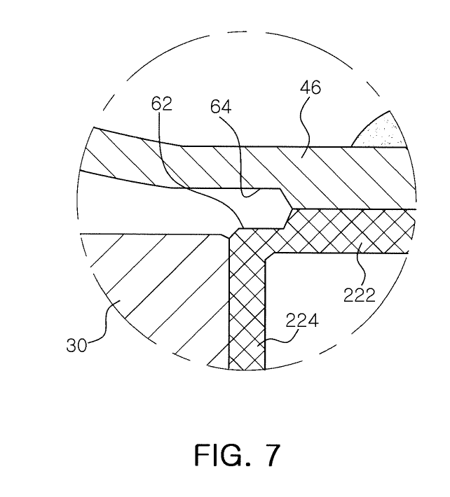

FIG. 5 is an enlarged cross-sectional view of part A of FIG. 2; FIG. 6 is an enlarged cross-sectional view showing a first modified example of part A of FIG. 2; and FIG. 7 is an enlarged cross-sectional view showing a second modified example of part A of FIG. 2.

Referring to FIGS. 5 through 7, a method of forming the clearance part 60 according to an exemplary embodiment of the present invention may be appreciated.

The clearance part 60 may be formed as a groove formed in at least one of the magnet fixing part 222 and the elastic member 40.

The exemplary embodiment of FIG. 5 shows a case in which a groove 62 is formed in the magnet fixing part 222 of the yoke 22. The exemplary embodiment of FIG. 6 shows a case in which a groove 64 is formed at the connecting point between the yoke fixing part 46 and the connecting strip part 44 in the direction from the connecting strip part 44 toward the housing fixing part 42.

The exemplary embodiment of FIG. 7 shows a case in which grooves 62 and 64 are formed in both the magnet fixing part 222 and the elastic member 40.

As set forth above, in a linear vibrator according to the exemplary embodiments of the present invention, the contact between connecting strip parts of an elastic member and a yoke is blocked during the generation of vibrations, whereby noise may be reduced.

In addition, no impact is applied to the connecting strip parts of the elastic member, whereby the life span of the linear vibrator may be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A linear vibrator comprising:
a housing having an internal space formed therein;
a magnetic field unit including a yoke disposed in the internal space and a magnet mounted on one surface of the yoke, and interacting with a coil to which power is applied to thereby generate vibrations in the internal space;
an elastic member configured of a housing fixing part fixed to an inner surface of the housing, a yoke fixing part surface-contacting the other surface of the yoke, and a plurality of connecting strip parts disposed such that an elastic space is formed between the housing fixing part and the yoke fixing part; and
a clearance part formed between the yoke and the yoke fixing part, and preventing the connecting strip parts from contacting the yoke during the vibrations of the magnetic field unit.

2. The linear vibrator of claim 1, wherein the yoke comprises:
a magnet fixing part having the magnet fixed thereto;
a mass body fixing part being bent from the magnet fixing part in a mounting direction of the magnet to fix a mass body; and
a claw part being bent from the mass body fixing part to support a bottom of the mass body.

3. The linear vibrator of claim 2, wherein the clearance part is a groove formed in at least one of the magnet fixing part and the elastic member.

4. The linear vibrator of claim 1, wherein the housing includes a cylindrical upper case of which a lower portion is open and a bracket closing the lower portion of the upper case and having the coil mounted thereon.

5. The linear vibrator of claim 1, wherein a yoke plate is provided on a surface opposite to a contact surface between the magnet and the yoke.

6. The linear vibrator of claim 1, wherein the coil has a cylindrical shape such that a space in which the magnetic field unit moves is formed, and
magnetic fluid preventing contact between the magnetic field unit and the coil is provided in a clearance therebetween.

7. The linear vibrator of claim 1, wherein the clearance part is formed within the yoke fixing part in a direction toward at least one of the connecting strip parts.

8. The linear vibrator of claim 1, wherein the clearance part is formed in a connecting point between the yoke fixing part and at least one of the connecting strip parts in a direction from the connecting strip part toward the housing fixing part.

9. The linear vibrator of claim 1, wherein the elastic member includes a spring member,
the yoke fixing part has a flat plate shape,
the housing fixing part has an annular rim shape in which a center is open, and
the connecting strip parts is a spiral-shaped elastic spring connecting the yoke fixing part and the housing fixing part.

10. The linear vibrator of claim 1, wherein the housing includes a damper formed on a surface thereof, the damper preventing the magnetic field unit from contacting the housing due to vibrations.

11. The linear vibrator of claim 1, wherein the yoke includes a magnet fixing part having one surface bonded to the yoke fixing part and the other surface fixed to the magnet, and
an area of a bonding surface between the magnet fixing part and the yoke fixing part is smaller than that of the yoke fixing part.

12. A linear vibrator comprising:
a cylindrical upper case of which a lower portion is open;
a bracket fixed to the open lower portion of the upper case to thereby form an internal space and having a coil fixed thereto, the coil having external power applied thereto;
a magnetic field unit including a yoke disposed in the internal space and a magnet mounted on one surface of the yoke, and interacting with the coil to which power is applied to thereby generate vibrations in the internal space;
an elastic member configured of a ring-shaped housing fixing part fixed to the upper case, a flat plate-shaped yoke fixing part fixed to the other surface of the yoke, and a plurality of spiral connecting strip parts disposed such that an elastic space is formed between the housing fixing part and the yoke fixing part; and
a clearance part formed between the yoke and the yoke fixing part, and preventing the connecting strip parts from contacting the yoke during the vibrations of the magnetic field unit.
